(19) United States
(12) Patent Application Publication
(10) Pub. No.: US 2013/0154445 A1
(43) Pub. Date: Jun. 20, 2013

(54) SPINDLE MOTOR

(71) Applicant: SAMSUNG ELECTRO-MECHANICS CO., LTD., Suwon (KR)

(72) Inventor: Sang Jae SONG, Suwon (KR)

(73) Assignee: SAMSUNG ELECTRO-MECHANICS CO., LTD., Suwon (KR)

(21) Appl. No.: 13/707,815

(22) Filed: Dec. 7, 2012

(30) Foreign Application Priority Data
Dec. 19, 2011 (KR) 10-2011-0137133

(51) Int. Cl. H02K 7/08

(52) U.S. Cl. CPC H02K 7/08
USPC 310/425

(57) ABSTRACT

There is provided a spindle motor including: a sleeve having a protrusion extending in a radial direction; a hub having a main wall part enclosing the sleeve; and a regulating member disposed between the main wall part and the sleeve, wherein the main wall part is provided with an adhesive injection hole so that an adhesive is injected between the regulating member and the main wall part.

### CROSS-REFERENCE TO RELATED APPLICATIONS

This application claims the priority of Korean Patent Application No. 10-2011-0137133 filed on Dec. 19, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor having a structure capable of improving adhesive force between a hub and a regulating member.

2. Description of the Related Art

A hard disk drive (HDD), an information storage device, is a device in which data may be stored on a disk or read therefrom, using a read/write head. The hard disk drive includes a disk driver driving a disk, for example, a small spindle motor.

The small spindle motor has a fluid dynamic bearing structure for the miniaturization of a motor. In the fluid dynamic bearing structure, a fluid (oil) filled between a shaft, a rotating member, and a sleeve, a fixed member, serves as a bearing in a mechanism structure.

The spindle motor for the HDD is rotated at high speed. For this reason, the shaft and a hub forming a rotating body may be separated from a base member.

In order to prevent this, a method of disposing a regulating member between the sleeve and the hub has been considered. However, an adhesive application space may not be able to be secured between the hub and the regulating member, such that it may be difficult to prevent the separation of the hub using the regulating member.

Meanwhile, there are provided Patent Documents 1 and 2 as the related art associated therewith.

However, Patent Document 1 discloses that a stopper member 80 is inserted into a hub base 220 in a press-fitting manner and thus, the stopper member 80 and the hub base 220 need to very precisely machined.

On the other hand, Patent Document 2 discloses a structure in which a hub 22 and an annular member 25 are coupled to each other by an adhesive, but cannot obtain a sufficient degree of adhesive force therebetween due to the absence of a space sufficient to inject an adhesive between the hub 22 and the annular member 25.

### RELATED ART DOCUMENT

(Patent Document 1) KR10-1026013 B1
(Patent Document 2) JP2003-333797 A

### SUMMARY OF THE INVENTION

An aspect of the present invention provides a spindle motor having a structure in which a sufficient amount of adhesive may be injected between a hub and a regulating member.

According to an aspect of the present invention, there is provided a spindle motor, including: a sleeve having a protrusion extending in a radial direction; a hub having a main wall part enclosing the sleeve; and a regulating member disposed between the main wall part and the sleeve, wherein the main wall part is provided with an adhesive injection hole so that an adhesive is injected between the regulating member and the main wall part.

The regulating member may be provided with a groove connected to the adhesive injection hole.

The groove may be extendedly formed in a circumferential direction of the regulating member.

The adhesive injection hole may include a plurality of adhesive injection holes formed to have a predetermined interval therebetween in a circumferential direction of the main wall part.

The regulating member may be provided with a plurality of grooves connected to the plurality of adhesive injection holes.

The plurality of grooves may be extendedly formed in the circumferential direction of the regulating member.

The plurality of grooves may be formed in parallel in the circumferential direction of the regulating member so as not to intersect.

The plurality of grooves may be connected to each other so that the adhesive injected through the individual adhesive injection holes is uniformly distributed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a spindle motor according to a first embodiment of the present invention;

FIG. 2 is a cross-sectional view of a spindle motor according to a second embodiment of the present invention;

FIG. 3 is a cross-sectional view of a spindle motor according to a third embodiment of the present invention;

FIG. 4 is a perspective view of a regulating member of FIG. 3 having a first shape;

FIG. 5 is a perspective view of the regulating member of FIG. 3 having a second shape; and

FIG. 6 is a perspective view of the regulating member of FIG. 3 having a third shape.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

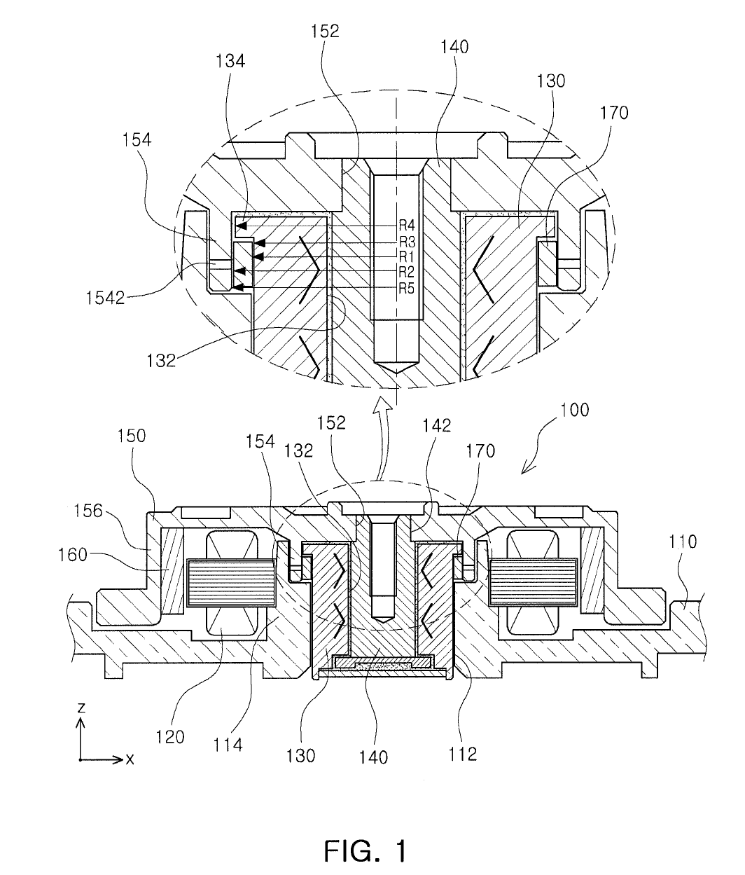

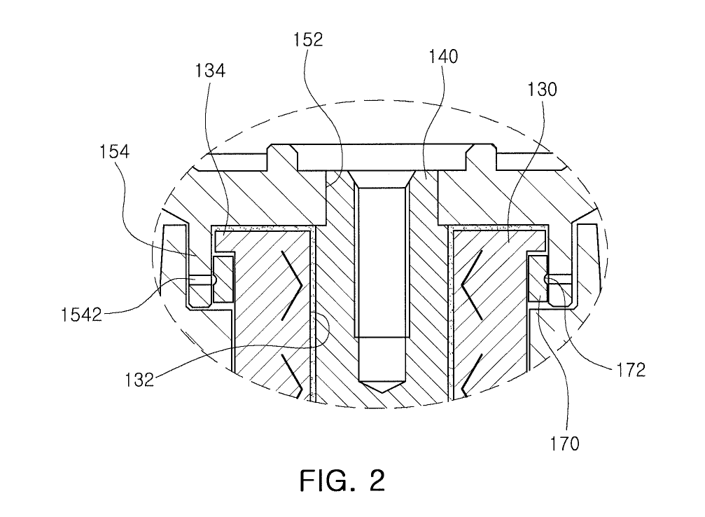

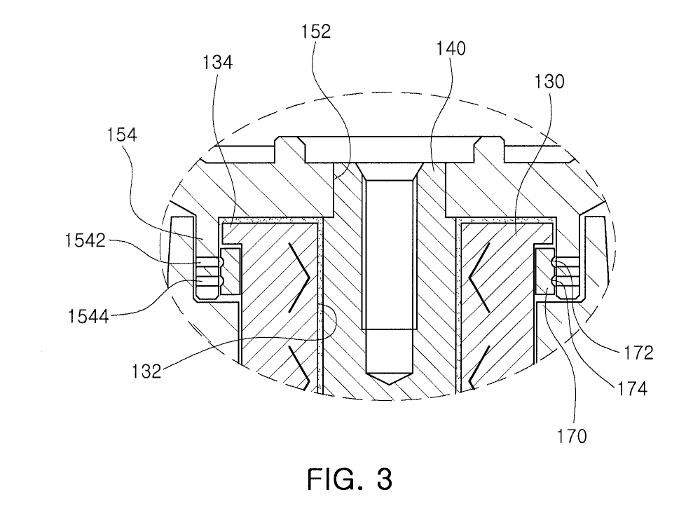

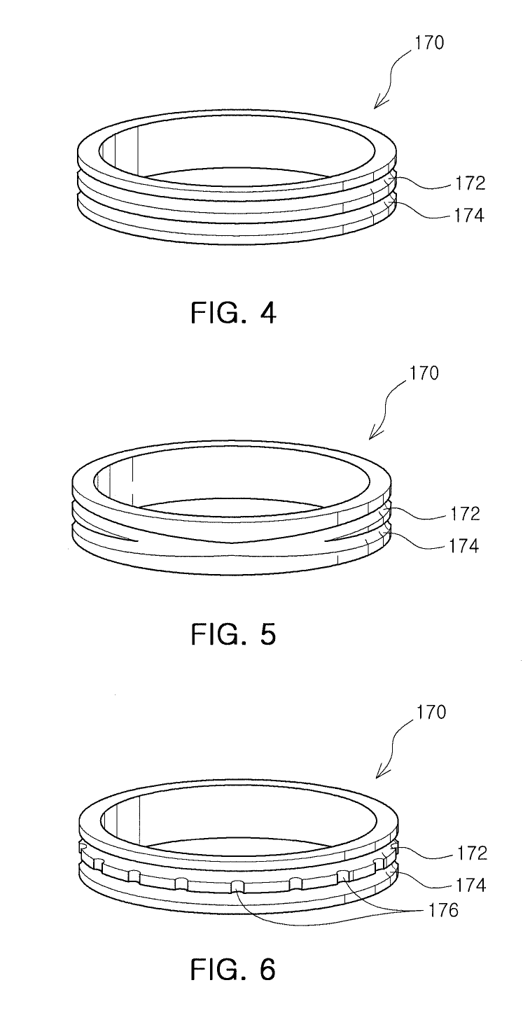

FIG. 1 is a cross-sectional view of a spindle motor according to a first embodiment of the present invention, FIG. 2 is a cross-sectional view of a spindle motor according to a second embodiment of the present invention, FIG. 3 is a cross-sectional view of a spindle motor according to a third embodiment of the present invention, FIG. 4 is a perspective view of a regulating member of FIG. 3 having a first shape, FIG. 5 is a perspective view of the regulating member of FIG. 3 having a second shape, and FIG. 6 is a perspective view of the regulating member of FIG. 3 having a third shape.

A spindle motor according to a first embodiment of the present invention will be described with reference to FIG. 1.

A spindle motor 100 according to the first embodiment of the present invention may include a base member 110, an electromagnet 120, a sleeve 130, a shaft 140, a hub 150, a permanent magnet 160, and a regulating member 170.

The base member 110 may be a member that is firmly fixed to a body of a hard disk drive device. Therefore, the base member 110 may be formed of the body of the hard disk drive device or may be a part thereof. The base member 110 may be formed of a metal material (for example, an aluminum alloy, or the like). The base member 110 may have a mounting hole 112 in which the sleeve 130 is mounted.

The mounting hole 112 may have a diameter having the same size as an outer diameter of the sleeve 130 or a diameter having a difference within a predetermined tolerance range. An edge of the mounting hole 112 may be provided with a first main wall part 114 protruded upwardly so as to stably support a circumference of the sleeve 130. The first main wall part 114 may be provided with a plurality of electromagnets 120.

The electromagnets 120 may be disposed in circular form, based on the mounting hole 112, and may be supplied with current from the outside to generate electromagnetic force. For this purpose, the electromagnets 120 may be configured of a core and a coil.

The sleeve 130 may be mounted in the mounting hole 112 of the base member 110. The sleeve 130 is firmly fixed to the base member 110 in a press-fitting manner and may be bonded thereto by an adhesive, or the like, if necessary. The sleeve 130 may have a through hole in which the shaft 140 may be accommodated. In this configuration, the through hole may be larger than an outer diameter of the shaft 140. That is, an appropriate interval may be maintained between an inner surface 132 of the sleeve 130 and an outer surface of the shaft 140 so that the sleeve 130 and the shaft 140 may serve as a fluid dynamic bearing.

The sleeve 130 may be provided with a protrusion 134 extending in a radial direction.

The protrusion 134 may be extendedly formed in a circumferential direction of the sleeve 130 and may be protruded toward a second main wall part 154 from a surface of the sleeve 130.

Meanwhile, although not shown, the inner surface 132 of the sleeve 130 may be provided with a comb-shaped fluid dynamic pressure groove so as to generate fluid dynamic pressure at the time of the rotation of the shaft 140.

The fluid dynamic pressure groove may have any one of a herringbone shape, a spiral shape, and a helical shape, but the shape of the fluid dynamic pressure groove is not limited thereto so long as it can generate dynamic pressure.

The shaft 140 may be rotatably mounted on the sleeve 130.

The shaft 140 is mounted while penetrating through the sleeve 130, and may have an extended part 142 extendedly formed outwardly of the sleeve 130 (upwardly, based on FIG. 1). A section of the extended part 142 may be the same as a section of the shaft 140, but may be different therefrom as in the present embodiment.

A circumference of the shaft 140 may be provided with a fluid dynamic pressure groove that performs the same or similar function as the fluid dynamic pressure groove formed in the inner surface 132 of the sleeve 130. Here, similar to the fluid dynamic pressure groove of the sleeve 130, the fluid dynamic pressure groove may have any one of a herringbone shape, a spiral shape, and a helical shape, but the shape of the fluid dynamic pressure groove is not limited thereto so long as it can generate dynamic pressure.

The hub 150 may be coupled to the shaft 140. Specifically, the hub 150 may be coupled to the extended part 142 of the shaft 140 and may be rotated together with the shaft 140.

The hub 150 may be provided with a shaft coupling hole 152 into which the shaft 140 is inserted. A size of the shaft coupling hole 152 may be the same as a section size of the extended part 142 within a tolerance range.

The hub 150 may be provided with the second main wall part 154 and a third main wall part 156.

The second main wall part 154 may extend downwardly in the vicinity of the shaft coupling hole 152 of the hub 150. The second main wall part 154 extending downwardly may enclose the circumference of the sleeve 130. The second main wall part 154 may suppress a fluid from being leaked to the outside of the sleeve 130.

The second main wall part 154 may be provided with an adhesive injection hole 1542.

The adhesive injection hole 1542 may penetrate through the second main wall part 154. In addition, the adhesive injection hole 1542 may extend to the regulating member 170. Therefore, when an adhesive is injected into the adhesive injection hole 1542, the adhesive may be injected up to the regulating member 170 disposed inwardly of the second main wall part 154 through the adhesive injection hole 1542.

The adhesive injection hole 1542 may have a section size gradually reduced or gradually increased toward the inside of the second main wall part 154 from the outside of the second main wall part 154. In the former case, the adhesive may be easily injected and in the latter case, the leakage of the injected adhesive may be prevented.

The adhesive injection holes 1542 may be formed to have a predetermined interval therebetween in the circumferential direction of the second main wall part 154. In this case, a large amount of adhesive may be injected through the plurality of adhesive injection holes 1542, such that the degree of adhesive force between the hub 150 and the regulating member 170 may be improved.

The third main wall part 156 may extend downwardly from an edge of the hub 150. The third main wall part 156 extending downwardly may enclose the outside of the electromagnet 120.

The third main wall part 156 may be provided with the permanent magnet 160. In addition, the permanent magnet 160 may be disposed on the third main wall part 156 so as to face the electromagnet 120 disposed on the first main wall part 114. The permanent magnet 160 generates electromagnetic force corresponding to the electromagnet 120. Therefore, the electromagnet 120 and the permanent magnet 160 form a predetermined magnitude of magnetic field to thereby rotate the shaft 140 and the hub 150.

The third main wall part 156 may be provided with a plurality of disks. Here, the disk may be a member that may record and reproduce magnetic information.

The regulating member 170 may be disposed between the sleeve 130 and the second main wall part 154 of the hub 150. The regulating member 170 is coupled to the hub 150 to prevent the hub 150 from floating.

The regulating member 170 may have an annular shape and may have a first radius R1 and a second radius R2. Here, the first radius R1, an inner radius of the regulating member 170, may be larger than a radius R3 of the sleeve 130 and may be smaller than a radius R4 of the protrusion 134. Further, the second radius R2, an outer radius of the regulating member 170, may be larger than the radius R4 of the protrusion 134 and may be smaller than or equal to an inner radius R5 of the second main wall part 154.

The regulating member 170 is not coupled to the sleeve 130 but may be coupled to the hub 150. Therefore, the regulating member 170 may be rotated together with the hub 150 when the hub 150 is rotated. However, since the regulating member 170 has the inner radius smaller than the radius of the protrusion 134, it contacts the protrusion 134 when the hub 150 floats to thereby suppress the hub 150 from floating.

Meanwhile, the regulating member 170 may form a gap together with the second main wall part 154 of the hub 150. This may occur due to the machining tolerance of the regulating member 170. Therefore, if the regulating member 170 and the hub 150 are not firmly bonded to each other by an adhesive, it may be difficult to suppress the floating of the hub 160 using the regulating member 170.

However, in the case of the spindle motor 100 according to the embodiment of the present invention, the adhesive may be injected through the adhesive injection hole 1542 to improve the degree of adhesive force between the hub 150 and the regulating member 170.

Therefore, in the spindle motor 100 according to the embodiment of the present invention, a z-axis direction location (based on FIG. 1) of the shaft 140 and the hub 150 is not changed due to the regulating member 170 even in the case in which the shaft 140 and the hub 150 are rotated at high speed, such that magnetic information stored on the disk may be accurately read or magnetic information may be accurately recorded on the disk.

Next, a spindle motor according to a second embodiment of the present invention will be described with reference to FIG. 2.

The spindle motor 100 according to the second embodiment of the present invention may be differentiated from the first embodiment of the present invention in terms of the shape of the regulating member 170. That is, the regulating member 170 may be provided with a groove 172 as illustrated in FIG. 2.

The groove 172 may be formed in a location facing the adhesive injection hole 1542.

Here, the groove 172 may be partially formed on the surface of the regulating member 170 or extendedly formed in the circumferential direction of the regulating member 170.

According to the second embodiment, a larger amount of adhesive may be injected between the hub 150 and the regulating member 170 through the groove 172 of the regulating member 170, thereby improving the degree of adhesive force between the hub 150 and the regulating member 170.

Next, a spindle motor according to a third embodiment of the present invention will be described with reference to FIGS. 3 to 6.

The spindle motor 100 according to the third embodiment of the present invention may be differentiated from the foregoing embodiments of the present invention in terms of the shape of the adhesive injection hole 1542 and the regulating member 170.

The adhesive injection hole 1542 may be formed in multiple rows. For example, the spindle motor 100 according to the third embodiment of the present invention may have a structure in which first and second adhesive injection holes 1542 and 1544 may be disposed vertically. Here, the individual adhesive injection holes 1542 and 1544 may be formed in the circumferential direction of the second main wall part 154 while having the same interval therebetween or having different intervals therebetween.

The adhesive injection holes 1542 and 1544 may easily allow the adhesive to be injected therethrough. For example, at least one of the plurality of adhesive injection holes 1542 and 1544 may be used as an outlet for air that is present between the hub 150 and the regulating member 170 during the injection of an adhesive.

The regulating member 170 may have a plurality of grooves 172 and 174 that correspond to respective adhesive injection holes 1542 and 1544.

Here, the grooves 172 and 174 may be formed in parallel with each other in the circumferential direction of the regulating member 170 as illustrated in FIG. 4. Alternatively, the grooves 172 and 174 may be formed to intersect in the circumferential direction of the regulating member 170 as illustrated in FIG. 5. Alternatively, the grooves 172 and 174 may be formed to be connected by another groove 176 as illustrated in FIG. 6.

As described above, the grooves 172, 174, and 176 having various shapes expand a surface area that may be coated with the adhesive between the hub 150 and the regulating member 170, thereby improving the degree of adhesive force between the hub 150 and the regulating member 170.

In particular, the regulating member 170 illustrated in FIGS. 5 and 6 may facilitate the injection of the adhesive evenly through one of the adhesive injection holes 1542 and 1544, since all the grooves 172, 174, and 176 are connected to one another.

As set forth above, according to the embodiments of the present invention, the degree of adhesive force between the hub and the regulating member can be increased.

Therefore, according to the embodiments of the present invention, the floating phenomenon of the hub can be effectively suppressed due to the regulating member.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a sleeve having a protrusion extending in a radial direction;
a hub having a main wall part enclosing the sleeve; and
a regulating member disposed between the main wall part and the sleeve,
wherein the main wall part is provided with an adhesive injection hole so that an adhesive is injected between the regulating member and the main wall part.

2. The spindle motor of claim 1, wherein the regulating member is provided with a groove connected to the adhesive injection hole.

3. The spindle motor of claim 2, wherein the groove is extendedly formed in a circumferential direction of the regulating member.

4. The spindle motor of claim 2, wherein the adhesive injection hole includes a plurality of adhesive injection holes formed to have a predetermined interval therebetween in a circumferential direction of the main wall part.

5. The spindle motor of claim 4, wherein the regulating member is provided with a plurality of grooves connected to the plurality of adhesive injection holes.

6. The spindle motor of claim 5, wherein the plurality of grooves are extendedly formed in the circumferential direction of the regulating member.

7. The spindle motor of claim 6, wherein the plurality of grooves are formed in parallel in the circumferential direction of the regulating member so as not to intersect.

8. The spindle motor of claim 6, wherein the plurality of grooves are connected to each other so that the adhesive injected through the individual adhesive injection holes is uniformly distributed.
